(19) United States
(12) Patent Application Publication
(10) Pub. No.: US 2013/0004981 A1
(43) Pub. Date: Jan. 3, 2013

(54) SYSTEM AND METHOD FOR SELECTING MOLECULE INTERACTING WITH PROTEIN PHOSPHATASE

(76) Inventors: Chi-Wu CHIANG, TAINAN CITY (TW); Shang-Ju CHIANG, Tainan City (TW); Shu-Ting MO, Tainan City (TW)

(21) Appl. No.: 13/523,231

(22) Filed: Jun. 14, 2012

Related U.S. Application Data
(60) Provisional application No. 61/498,005, filed on Jun. 17, 2011.

(51) Int. Cl. G01N 21/64

(52) U.S. Cl. 435/21

(57) ABSTRACT

A system and a method for selecting a molecule interacting with protein phosphatase are disclosed. The fluorescence protein detecting system for selecting a molecule interacting with protein phosphatase includes: a scaffold subunit A; a regulatory subunit B; a catalytic subunit C; a first fluorescence protein, which includes a first part and a second part, wherein the first part and the second part are separated from each other; and a second fluorescence protein, wherein the emission spectrum of the second fluorescence protein overlaps with the excitation spectrum of the first fluorescence protein. When the second part of the first fluorescence protein is fused with the regulatory subunit B, the second fluorescence protein is fused with the catalytic subunit C, alternatively. When the second part of the first fluorescence protein is fused with the catalytic subunit C, the second fluorescence protein is fused with the regulatory subunit B.

### CROSS REFERENCE TO RELATED APPLICATION

This application claims the benefit of filing date of U.S. Provisional Application Ser. No. 61/498,005, entitled “Establishing a Bimolecular Fluorescence Complementation (BiFC)-Based Fluorescence Resonance Energy Transfer (FRET) Method to Visualize PP2A Holoenzymes in Cells” filed Jun. 17, 2011 under 35 USC §119(e)(1).

### BACKGROUND OF THE INVENTION

1. Field of the Invention

The present invention relates to a system and a method for selecting a molecule interacting with protein phosphatase and, more particularly, to a system and a method for selecting a molecule interacting with protein phosphatase by employing bimolecular fluorescence complementation (BiFC) together with fluorescence resonance energy transfer (FRET) analysis.

2. Description of Related Art

Protein phosphatases are enzymes for dephosphorylation, which are different from protein kinases phosphorylating proteins. Protein phosphatases can be divided into tyrosine phosphatase and serine/threonine phosphates, wherein the serine/threonine phosphates can further be divided into PPM and PPP families. Furthermore, the PPP family includes PP1, PP2A, PP2B, PP4, PP5, PP6 and PP7, and the PPM family includes PP2C and pyruvate dehydrogenase.

Many biological processes are completed by several protein-protein interactions. Hence, the features and conformational changes generated in the protein-protein interactions are key points for biological mechanism studies. Currently, yeast two-hybrid system, mammalian two-hybrid system, co-immunoprecipitation and pull down assay can be used to study the protein-protein interactions.

Although these methods can be used to confirm interactions between proteins, localizations and conformational changes of the proteins still cannot be observed by the aforementioned methods. Hence, bimolecular fluorescence complementation (BiFC) and fluorescence resonance energy transfer (FRET) analyses are currently developed to solve these problems. However, when these two fluorescence methods are individually performed on protein phophatases with three subunits, BiFC or FRET analysis has to be performed at least two times to confirm the features and conformational changes of proteins. Hence, it is desirable to provide a method which can simultaneously observe protein-protein interaction of three subunits in vivo, to observe dynamic interactions between proteins and localizations of proteins, and therefore the method can be applied to novel drug developments.

### SUMMARY OF THE INVENTION

The object of the present invention is to provide a system for selecting a molecule interacting with protein phosphatase, which can be applied to studies about interactions between subunits of protein phosphatase.

Another object of the present invention is to provide a method for selecting a molecule interacting with protein phosphatase, which can effectively select molecules interacting with subunits of protein phosphatase. Therefore, the method of the present invention can be applied to the development of novel drugs.

The system for selecting a molecule interacting with protein phosphatase by using fluorescence proteins comprises: a scaffold subunit; a regulatory subunit; a catalytic subunit; a first fluorescence protein, which includes a first part, and a second part, wherein the first part and the second part are apart from each other, and the first part is fused with the scaffold subunit; and a second fluorescence protein, wherein an emission spectrum of the second fluorescence protein overlaps with an excitation spectrum of the first fluorescence protein. When the second part of the first fluorescence protein is fused with the regulatory subunit, the second fluorescence protein is fused with the catalytic subunit. Alternatively, when the second part of the first fluorescence protein is fused with the catalytic subunit, the second fluorescence protein is fused with the regulatory subunit.

According to the system of the present invention, the protein phosphatase is protein phosphatase 2A (PP2A). PP2A comprises the scaffold subunit, the regulatory subunit and the catalytic subunit. The scaffold subunit and the catalytic subunit associate with each other to form a stable dimmer as a core enzyme, which represents one-third of the whole PP2A holoenzyme. In addition, various regulatory subunits assemble into the core enzyme to determine the substrate specificity and the subcellular localization of PP2A respectively. Generally, the scaffold subunit of PP2A is represented as an A subunit, the regulatory subunit thereof is represented as a B subunit, and the catalytic subunit thereof is represented as a C subunit.

The regulatory subunit can be classified into four families including B family, B′ family, B″ family and B′″ family, and may contain other molecules such as SV40 small T antigen and phosphotyrosyl phosphatase activator (PTPA). Preferably, the regulatory subunit is B55β₂ and B56γ₃, and the cellular activities thereof are well studied. More specifically, the B family relates to cell differentiation and contains four isoforms including B55α, B55β, B55γ, and B55δ, wherein the subcellular distribution of B55β₂ is shown in mitochondria and B55β₂ promotes apoptosis during growth factors depletion in neuronal cells. The B′ family relates to cell cycle progression and contains five isoforms including B56α, B56β, B56γ, B56δ, and B56ε, wherein B56γ₃ participates in p53-mediated tumor suppression, shuttles between nucleus and cytoplasm during cell cycle progressions, and regulates p27 phosphorylation which results in elevated p27 levels. The B″ family participates in cell cycle regulation and the B′″ family participates in cytoskeleton reorganization. In addition, PP2A is also a tumor suppressor, so the system of the present invention can be applied to selections of novel PP2A regulatory molecules, which can facilitate or inhibit the formation of trimeric PP2A assembly, to discover novel drugs for treating cancers or other diseases induced by regulating disorders of PP2A.

When the first part of the first fluorescence protein is an N-terminal fragment, the second part thereof is a C-terminal fragment. Alternatively, when the second part of the first fluorescence protein is an N-terminal fragment, the first part thereof is a C-terminal fragment. In addition, the first fluorescence protein may be a yellow fluorescence protein (YFP). An excitation spectrum of the yellow fluorescence protein can be 450-500 nm, and preferably is 480 nm. An emission spectrum of the yellow fluorescence protein can be 500-550 nm, and preferably is 530 nm. The second fluorescence protein may be a cyan fluorescence protein (CFP). An excitation spectrum of the cyan fluorescence protein can be 400-550 nm, and preferably is 430 nm. An emission spectrum of the cyan fluorescence protein can be 450-500 nm, and preferably is 480 nm. In order to determine whether the system is an effective system or not, an orientation of the N-terminal fragment or the C-terminal fragment of different fluorescence proteins, or a fusion pattern of the N-terminal fragment or the C-terminal fragment thereof have to be determined, since conformational changes may occur after the fluorescence proteins are fused with subunits of protein phosphatase.

The present invention further provides a method for selecting a molecule interacting with protein phosphatase by using fluorescence proteins, which comprises the following steps: (A) providing a system for selecting a molecule interacting with protein phosphatase, which comprises: a scaffold subunit; a regulatory subunit; a catalytic subunit; a first fluorescence protein, which includes a first part and a second part, wherein the first part and the second part are separated from each other, and the first part is fused with the scaffold subunit; and a second fluorescence protein, wherein an emission spectrum of the second fluorescence protein overlaps with an excitation spectrum of the first fluorescence protein; wherein the second fluorescence protein is fused with the catalytic subunit when the second part of the first fluorescence protein is fused with the regulatory subunit, and alternatively the second fluorescence protein is fused with the regulatory subunit when the second part of the first fluorescence protein is fused with the catalytic subunit; (B) mixing a sample with the system to obtain a mixture; and (C) providing an excitation light to the mixture and the system without adding any samples respectively, and detecting emission lights generated from the mixture and the system without adding any samples respectively, wherein the excitation light corresponds to the excitation spectrum of the first fluorescence protein, and the system without adding any samples is used as a blank. When an emitting signal generated from the mixture is different from that generated from the blank, it indicates that the sample participates in an interaction between the scaffold subunit, the regulatory subunit and the catalytic subunit. Hence, the aforementioned method and system for selecting a molecule interacting with protein phosphatase of the present invention can be used to select molecules, which may facilitate or inhibit the formation of trimeric PP2A assembly. Therefore, the system and the method of the present invention can be used to discover novel drugs for treating cancers or other diseases induced by regulating disorders of PP2A.

According to the method for selecting a molecule interacting with protein phosphatase of the present invention, when the emitting signal generated from the mixture is larger than that generated from the blank, it indicates that the sample can facilitate the interaction between the scaffold subunit, the regulatory subunit and the catalytic subunit. Otherwise, when the emitting signal generated from the mixture is smaller than that generated from the blank, it indicates that the sample may inhibit the interaction between the scaffold subunit, the regulatory subunit and the catalytic subunit.

In addition, BiFC shows sensitive and stable fluorescence, but it is an irreversible interaction. Although FRET analysis can present dynamics of protein association, it is limited to the distance between two proteins. Hence, the system and the method for selecting a molecule interacting with protein phosphatase of the present invention combines BiFC and FRET, and therefore the present invention can break through the limitations of these two methods and investigate a novel system and method by using fluorescence proteins. Furthermore, the association and interaction between three subunits can be simultaneously visualized in vivo by use of the method and the system of the present invention. Hence, the method and the system of the present invention can facilitate observations on dynamic interactions between proteins and localizations thereof, and developments of novel drugs for treating cancers or other diseases induced by regulating disorders of PP2A.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view showing a system of the present invention;

FIG. 2 is a perspective view showing combinations of a first fluorescence protein with subunits according to Embodiment 1 of the present invention;

FIG. 3 is a diagram showing fluorescent signal intensities according to Embodiment 2 of the present invention; and

FIG. 4 is diagram showing fluorescent signal intensities according to Embodiment 3 of the present invention.

### DETAILED DESCRIPTION OF THE PREFERRED EMBODIMENT

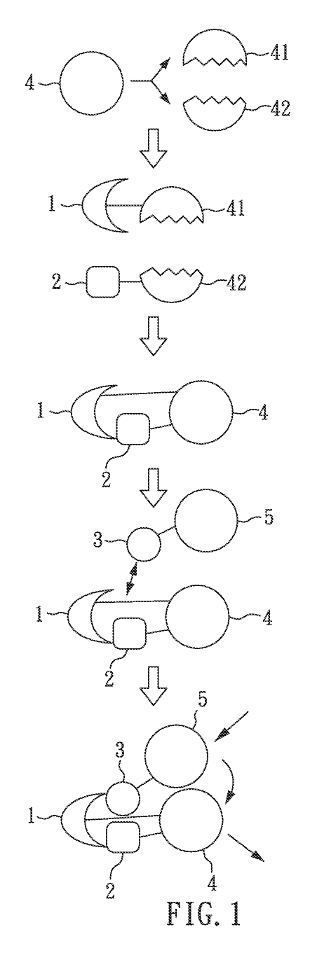

FIG. 1 is a perspective view showing one example of a system for selecting a molecule interacting with protein phosphatase of the present invention. As shown in FIG. 1, the system of the present invention comprises a scaffold subunit 1, a regulatory subunit 2, a catalytic subunit 3, and a first fluorescence protein 4 including a first part 41 of N-terminal fragment thereof and a second part 42 of C-terminal fragment thereof, and the first part 41 and the second part 42 are separated from each other. The first part 41 is fused with the scaffold subunit 1, and the second part 42 is fused with the regulatory subunit 2. The first part 41 and the second part 42, which are separated from each other originally, can assemble with each other to form a complete first fluorescence protein 4, when the scaffold subunit 1 associates with the regulatory subunit 2. Then, the catalytic subunit 3 fused with a second fluorescence protein 5 may assemble with the scaffold subunit 1 and the regulatory subunit 2. When an excitation light with a wavelength of 430 nm is provided on the second fluorescence protein 5, the second fluorescence protein 5 can generate an emitting light with a wavelength of 480 nm. When the first fluorescence protein 4 accepts the emitting light from the second fluorescence protein 5, the first fluorescence protein 4 can be excited to generate an emitting light with a wavelength of 530 nm. In this case, the emitting light of the first fluorescence protein 4 can be detected. After the aforementioned process, the interaction between the subunits of protein phosphatatase can be observed through the system of the present invention.

In the following embodiments of the present invention, the first fluorescence protein 3 is a yellow fluorescence protein (YFP), and the second fluorescence protein 5 is a cyan fluorescence protein (CFP). In addition, the scaffold subunit of PP2A is represented as an A subunit, the regulatory subunit thereof is represented as a B subunit, and the catalytic subunit thereof is represented as a C subunit.

### [NIH3T3 Cells Transfection]

In the following embodiments of the present invention, NIH3T3 cells (mouse embryonic fibroblast cell line) was used, which was cultured in Dulbecco's modified Eagle's medium (DMEM) supplemented with 10% bovine serum (BS), 1% Penicillin (10 U/μl)/Streptomycin (10 μg/μl), and 1% L-Glutamine (200 mM). All of the reagents were available from GIBCO.

NIH3T3 cells were seeded into proper dishes one day before transfection. For example, 7×10⁴ cells were seeded in each well of a 24-well plate; 10⁶ cells were seeded in a 6 cm dish; and 3×10⁶ cells were seeded in a 10 cm dish. After 12-16 hrs, two 1.5 ml eppendorfs were prepared, wherein one was used to prepare DNA mixture, and the other one was used to prepare Lipofectamine 2000 mixture. DNA constructs (μg) and Lipofectamine 2000 (μl) were added into each eppendorf in a ratio of 1:2, after 50 μl of Opti-MEM (GIBCO) was respectively added into each eppendorf. Then, the DNA mixtures were slowly dropped into the Lipofectamine 2000 mixtures respectively, and incubated for 20 min. The resultant mixtures were slowly dropped into cells, and incubated for 4-6 hr. Then, the medium was replaced with fresh DMEM and continuously incubated for further 24 hr.

### Embodiment 1

Plasmids containing cDNAs of Aα or Cα flanked with restriction enzyme cutting sites EcoRI and NheI were used as templates, and cDNAs of Aα or Cα were obtained by PCR. Next, the obtained cDNAs were subsequently cloned into pFLAG-CMV2-YFPN. In addition, plasmids containing cDNAs of Aα or Cα flanked with restriction enzyme cutting sites EcoRI and KpnI were used as templates, and cDNAs of Aα or Cα were obtained by PCR. Next, the obtained cDNAs were subsequently cloned into pCMV2-HA-YFPC. Herein, pFL AG-CMV2-Aα-YFPN was constructed with a forward primer represented by SEQ ID NO: 1 and a reverse primer represented by SEQ ID NO: 2; pFLAG-CMV2-Cα-YFPN was constructed with a forward primer represented by SEQ ID NO: 3 and a reverse primer represented by SEQ ID NO: 4; pCMV2-HA-Aα-YFPC was constructed with a forward primer represented by SEQ ID NO: 5 and a reverse primer represented by SEQ ID NO: 6; and pCMV2-HA-Cα-YFPC was constructed with a forward primer represented by SEQ ID NO: 7 and a reverse primer represented by SEQ ID NO: 8.

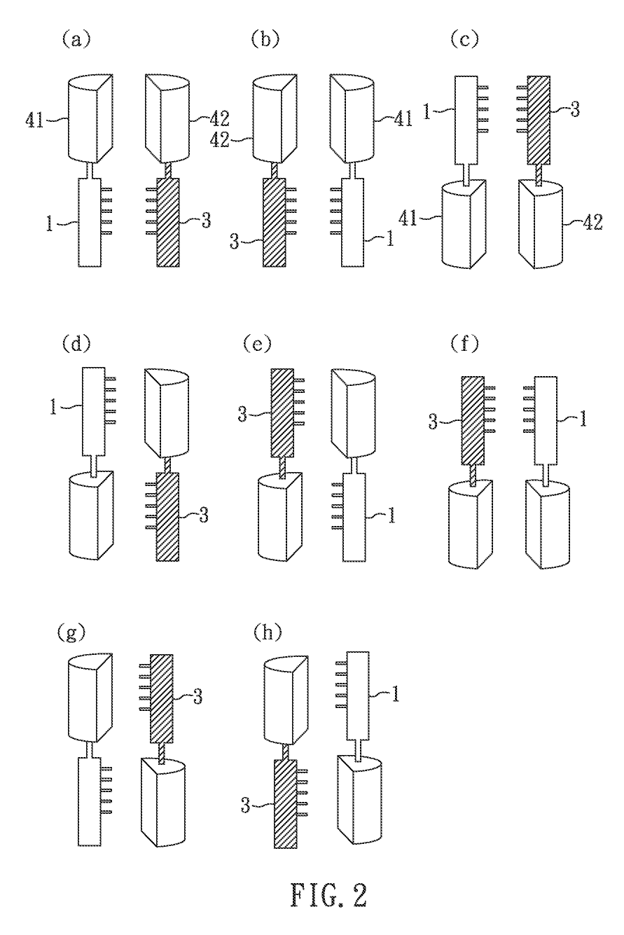

The example groups of the present embodiment are shown in FIG. 2. Herein, the first part 41 of a first fluorescence protein is an N-terminal fragment of YFP, which is represented as YFPN; and the second part 42 thereof is a C-terminal fragment of YFP, which is represented as YFPFC. In addition, the scaffold subunit 1 is Aα, and the catalytic subunit 3 is Cα. There were eight example groups used in the present embodiment, which were represented as follows: (a) YFPN-Aα+YFPC-Cα, (b) YFPN-Cα+YFPC-Aα, (c) Aα-YFPN+Cα-YFPC, (d) Cα-YFPN+Aα-YFPC, (e) Aα-YFPN+YFPC-Cα, (f) Cα-YFPN+YFPC-Aα, (g) YFPN-Aα+Cα-YFPC, and (h) YFPN-Cα+Aα-YFPC.

Cover glasses were placed into 24-well plates and coated with 0.01% poly-L-lysine (Sigma, P8920) for 15 min at room temperature. The aforementioned transfection process was performed to transfect plasmids of groups (a)-(h) into NIH3T3 cells.

After 24 hrs, cells were washed with PBS buffer three times and fixed by 4% paraformaldehyde/0.025% glutaraldehyde for 15 ruin. Next, the fixed cells were washed with PBS buffer three times, and stained with DAPI (5 μM) for 5 min. The stained cells were washed with PBS buffer three times, and then the cover glasses were picked up, inverted and put on slides filled with mounting medium. The cover glasses and the slides were sealed with nail polish. The cells were observed by fluorescence microscopy (Zeiss, Axio observer Z1). The results (data not shown) show that fluorescence was observed in each group, and especially the cells transfected with plasmid YFPN-Aα+YFPC-Cα (group (a)) can produce the best fluorescence and efficiency. In addition, the localization of complex of YFPN-Aα and YFPC-Cα was major in cytosol, and a few in the nucleus.

### Embodiment 2

The plasmids used in the present embodiment are shown as follows:

YFPN-B56γ3: A plasmid containing cDNA of B56γ3 was used as a template, cDNA of B56γ3 was obtained by PCR, and the obtained cDNA was subsequently cloned into pcDNA3.1/Zeo(+) to obtain pcDNA3.1/Zeo(+)-B56γ3-HA. Next, pcDNA3.1/Zeo(+)-B56γ3-HA was digested with restriction enzyme BamHI and XhoI, and the obtained insert was cloned into pcDNAI-YFPN to obtain a BiFC expression vector.

YFPC-Aα: A plasmid containing cDNAs of Aα was used as a template, cDNA of Aα was obtained by PCR, and the obtained cDNA was subsequently cloned into pcDNA3.1/Zeo(+) to obtain pcDNA3.1/Zeo(+)-Aα. Next, pcDNA3.1/Zeo(+)-Aα was digested with restriction enzyme BamHI and NotI, and the obtained insert was cloned into pcDNAI-YFPC to obtain another BiFC expression vector.

CFP-Cα: Plasmids containing cDNA of Cα flanked with restriction enzyme cutting sites BamHI and EcoRI was used as a template, and cDNA of Flag Cα was obtained by PCR. Next, cDNA of Cα was inserted into N-terminal or C-terminal part of CFP expression vector (pECFP-N₁/C₁).

Herein, the construct of pECFP-N₁-Flag-Cα was constructed by using a forward primer represented by SEQ ID NO: 9 and a reverse primer represented by SEQ ID NO: 10.

ST and STmt: “ST” and “STmt” represent pCMV5-small T and pCMV5-small T mt respectively, and both of them are provided by Dr. Estelle Sontag from the University of Newcastle (Australia). ST may influence the association between the scaffold subunit and the regulatory subunit. STmt is a mutation in which the amino acid sequence from amino acid residues 110 was deleted, so STmt cannot influence the association between the scaffold subunit and the regulatory subunit.

In the present embodiment, the plasmids of the following experimental groups were transfected into NIH3T3 cells with the aforementioned transfection process, and the cover glasses used in the present embodiment were prepared with the same process described in Embodiment 1. The cells were observed by fluorescence microscopy (Zeiss, Axio observer Z1), and the fluorescence and fluorescent efficiency generated from cells were programmed by Zeiss AxioVision complied with Youvan's method.

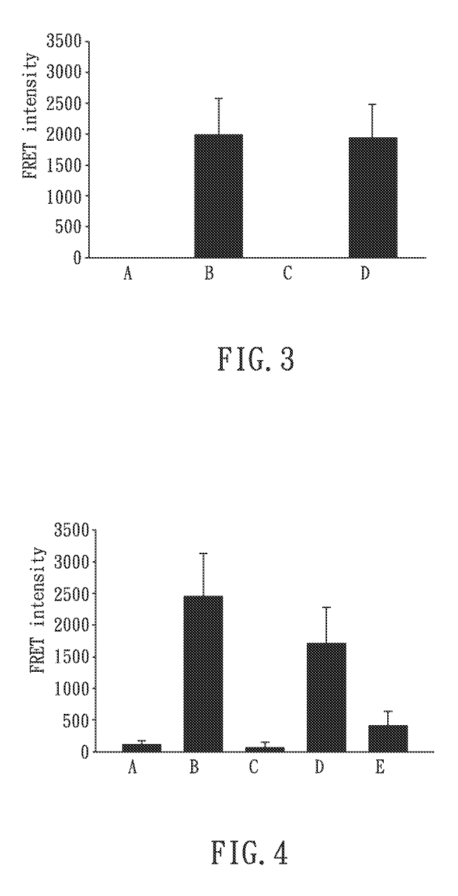

The four experimental groups of the present embodiment were YFPN+YFPC-Aα+CFP-Cα (A), YFPN-B5γ3+YFPC-Aα+CFP-Cα (B), YFPN-B56γ3+YFPC-Aα+CFP-Cα+ST (C), and YFPN-B56γ3+YFPC-Aα+CFP-Cα+STmt (D), and the results are shown in FIG. 3.

As shown in FIG. 3, the cells transfected with plasmid of group (B) can produce high fluorescence and efficiency, and it indicates that the subunits of YFPN-B56γ3, YFPC-Aα and CFP-Cα are well associated with each other. According to the results of group (A), it indicates that the system of the present embodiment has high specificity. In addition, the cells of group (C) did not generate any fluorescence, and it indicates that the association between subunits A and B was inhibited when ST was exhibited. However, the fluorescence generated from the cells of group (D) was not influenced when STmt was exhibited.

### Embodiment 3

The plasmids used in the present embodiment are shown as follow.

YFPC-Aα and Cα-YFPC: These two plasmids were constructed by the same method as described in Embodiment 1.

B55β2/B55β2mt-CFP: A plasmid containing cDNA of B55β2/B55β2mt flanked with restriction enzyme cutting sites BamHI and SalI was used as a template, and cDNA of B55β2/B55β2mt was obtained by PCR. Next, cDNA of B55β2/B55β2mt was inserted into an N-terminal or C-terminal of CFP expression vector (pECFP-N₁/C₁). Herein, the constructs of pECFP-N₁Flag-B55β2, pECFP-C₁-Flag-B55β2, pECFP-N1-Flag-B55β2mt and pECFP-C₁-Flag-B55β2 mt were constructed by using a forward primer represented by SEQ ID NO: 11 and a reverse primer represented by SEQ ID NO: 12. B55β2mt is a mutation in which the amino acid residues 167 and 168 of B55β2 were mutated from arginine to glutamic acid, so B55β2mt cannot associate with the scaffold subunit.

ST and STmt: The source and the usage thereof are the same as those described in Embodiment 2.

In the present embodiment, the plasmids of the following experimental groups were transfected into NIH3T3 cells with the aforementioned transfection process, and the cover glasses used in the present embodiment were prepared with the same process described in Embodiment 1. The cells were observed by fluorescence microscopy (Zeiss, Axio observer Z1), and the fluorescence and fluorescent efficiency generated from cells were programmed by Zeiss AxioVision complied with Youvan's method.

There were five experimental groups in the present embodiment, which respectively were: (A) YFPN+Cα-YFPC+B55β2-CFP, (B) YFPN-Aα+Cα-YFPC+B55β2-CFP, (C) YFPN-Aα+Cα-YFPC+B55β2-CFP+ST, (D) YFPN-Aα+Cα-YFPC+B55β2-CFP+STmt, and (E) YFPN-Aα+Cα-YFPC+B55β2mt-CFP. The results are shown in FIG. 4.

As shown in FIG. 4, the cells transfected with plasmid of group (B) can produce high fluorescence and efficiency, and it indicates that the subunits of YFPN-Aα, Cα-YFPC and B55β2-CFP were well associated with each other. The cells transfected with plasmid of group (B) showed weak fluorescence and efficiency, which indicates that the system of the present embodiment has high specificity. In addition, the cells of group (C) only generated weak fluorescence and efficiency, which indicates that the association between subunits A and B was inhibited when ST was exhibited. However, the fluorescence generated from the cells of group (D) was not influenced when STmt was exhibited. Furthermore, the fluorescence and efficiency generated from the cells of group (E) was much lower than that generated from the cells of group (B), when the plasmid of B55β2-CFP in group (B) was substituted with the plasmid of B55β2mt-CFP in group (E).

In addition, the fluorescence signals generated from cells of group (B) occurred in a punctuate manner similar to that of mitochondria (data not shown). This result indicates that the original function of B55β2 is not influenced when B55β2 is fused with CFP.

In conclusion, the system for selecting a molecule interacting with protein phosphatase of the present invention can sensitively detect the fluorescence after the subunits of protein phosphatase are associated with each other. Therefore, the method and the system of the present invention can be used to find molecules interacted with protein phosphatase.

Although the present invention has been explained in relation to its preferred embodiment, it is to be understood that many other possible modifications and variations can be made without departing from the spirit and scope of the invention as hereinafter claimed.

What is claimed is:

1. A system for selecting a molecule interacting with protein phosphatase, comprising:
a scaffold subunit;
a regulatory subunit;
a catalytic subunit;
a first fluorescence protein, which includes a first part and a second part, wherein the first part and the second part are separated from each other, and the first part is fused with the scaffold subunit; and
a second fluorescence protein, wherein an emission spectrum of the second fluorescence protein overlaps with an excitation spectrum of the first fluorescence protein;
wherein the second fluorescence protein is fused with the catalytic subunit when the second part of the first fluorescence protein is fused with the regulatory subunit, and alternatively the second fluorescence protein is fused with the regulatory subunit when the second part of the first fluorescence protein is fused with the catalytic subunit.

2. The system as claimed in claim 1, wherein the protein phosphatase is protein phosphatase 2A (PP2A).

3. The system as claimed in claim 1, wherein the second part of the first fluorescence protein is a C-terminal fragment when the first part thereof is an N-terminal fragment.

4. The system as claimed in claim 1, wherein the first part of the first fluorescence protein is a C-terminal fragment when the second part thereof is an N-terminal fragment.

5. The system as claimed in claim 1, wherein the first fluorescence protein is a yellow fluorescence protein.

6. The system as claimed in claim 5, wherein an excitation spectrum of the yellow fluorescence protein is 450-500 nm, and an emission spectrum thereof is 500-550 nm.

7. The system as claimed in claim 1, wherein the second fluorescence protein is a cyan fluorescence protein.

8. The system as claimed in claim 7, wherein an excitation spectrum of the cyan fluorescence protein is 400-550 nm, and an emission spectrum thereof is 450-500 nm.

9. A method for selecting a molecule interacting with protein phosphatase, comprising the following steps:
(A) providing a system for selecting a molecule interacting with protein phosphatase, which comprises:
a scaffold subunit;
a regulatory subunit;
a catalytic subunit;
a first fluorescence protein, which includes a first part and a second part, wherein the first part and the second part are apart from each other, and the first part is fused with the scaffold subunit; and
a second fluorescence protein, wherein an emission spectrum of the second fluorescence protein overlaps with an excitation spectrum of the first fluorescence protein;
wherein the second fluorescence protein is fused with the catalytic subunit when the second part of the first fluorescence protein is fused with the regulatory subunit, and alternatively the second fluorescence protein is fused with the regulatory subunit when the second part of the first fluorescence protein is fused with the catalytic subunit;
(B) mixing a sample with the system to obtain a mixture; and
(C) providing an excitation light to the mixture and the system without adding any samples respectively, and detecting emission lights generated from the mixture and the blank respectively, wherein the excitation light corresponds to the excitation spectrum of the first fluorescence protein, the system without adding any samples are used as a blank, and when an emitting signal generated from the mixture is different from that generated from the blank, which indicates that the sample participates in an interaction between the scaffold subunit, the regulatory subunit and the catalytic subunit.

10. The method as claimed in claim 9, wherein when the emitting signal generated from the mixture is larger than that generated from the blank, it indicates that the sample facilitates the interaction between the scaffold subunit, the regulatory subunit and the catalytic subunit; and when the emitting signal generated from the mixture is smaller than that generated from the blank, it indicates that the sample inhibits the interaction between the scaffold subunit, the regulatory subunit and the catalytic subunit.

11. The method as claimed in claim 9, wherein the protein phosphatase is protein phosphatase 2A (PP2A).

12. The method as claimed in claim 9, wherein the second part of the first fluorescence protein is a C-terminal fragment when the first part thereof is an N-terminal fragment.

13. The method as claimed in claim 9, wherein the first part of the first fluorescence protein is a C-terminal fragment when the second part thereof is an N-terminal fragment.

14. The method as claimed in claim 9, wherein the first fluorescence protein is a yellow fluorescence protein.

15. The method as claimed in claim 14, wherein an excitation spectrum of the yellow fluorescence protein is 450-500 nm, and an emission spectrum thereof is 500-550 nm.

16. The method as claimed in claim 9, wherein the second fluorescence protein is a cyan fluorescence protein.

17. The method as claimed in claim 16, wherein an excitation spectrum of the cyan fluorescence protein is 400-550 nm, and an emission spectrum thereof is 450-500 nm.
